(19) United States
(12) Patent Application Publication
(10) Pub. No.: US 2025/0055207 A1
(43) Pub. Date: Feb. 13, 2025

(54) SHIELD TERMINAL

(71) Applicant: SUMITOMO WIRING SYSTEMS, LTD., Mie (JP)

(72) Inventor: Wataru YAMANAKA, Mie (JP)

(21) Appl. No.: 18/796,896

(22) Filed: Aug. 7, 2024

(30) Foreign Application Priority Data
Aug. 10, 2023 (JP) 2023-130787

(51) Int. Cl. H01R 4/70; H01R 4/18

(52) U.S. Cl. CPC H01R 4/70; H01R 4/185

(57) ABSTRACT

A first outer conductor 12 of a shield terminal 1 includes a rear bottom plate portion, a pair of left and right first side plate portions extending upward from the rear bottom plate portion, and a first opening formed between upper ends of the first side plate portions. A second outer conductor 13 of the shield terminal 1 includes a covering portion that covers the first opening, and a pair of left and right second side plate portions extending downward from the covering portion. Each of the second side plate portions includes a curved portion that is disposed above the rear bottom plate portion and between the first side plate portions, and that is curved outward in a left-right direction from an upper end to a lower end of the curved portion.

### CROSS-REFERENCE TO RELATED APPLICATIONS

This application is based on and claims priority from Japanese Patent Application No. 2023-130787, filed on Aug. 10, 2023, with the Japan Patent Office, the disclosure of which is incorporated herein in its entirety by reference.

### TECHNICAL FIELD

The present disclosure relates to a shield terminal.

### BACKGROUND

JP 2021-157974 A discloses a shield terminal formed by attaching an outer conductor made of metal and a cover member made of metal to a terminal end portion of a shielded wire. The outer conductor includes a pair of left and right side wall portions. The cover member includes a pair of left and right side plate portions that are inserted between the side wall portions.

### SUMMARY

In the case of the configuration disclosed in JP 2021-157974 A, in order to facilitate the insertion of the side plate portions between the side wall portions, it is preferable that the dimension between outer sides of the two side plate portions (the distance between outer surfaces of the side plate portions in the left-right direction) is set to be smaller than the dimension between inner sides of the side wall portions (the distance between inner surfaces of the side wall portions in the left-right direction). However, with such dimension settings, shield terminals in which the side wall portions and the corresponding side plate portions are in contact with each other, and shield terminals in which the side wall portions and the corresponding side plate portions are not in contact with each other may be manufactured due to variations in mounting and the like, and there is a concern that signal transmission performance may vary among shield terminals.

Therefore, an object of the present disclosure is to provide a shield terminal that can suppress variations in signal transmission performance, thus achieving improved signal transmission performance.

A shield terminal according to the present disclosure includes: a first outer conductor and a second outer conductor that are connectable to each other, wherein the first outer conductor includes a bottom plate portion, a pair of left and right first side plate portions extending upward from the bottom plate portion, and an opening formed between upper ends of the first side plate portions, the second outer conductor includes a covering portion that covers the opening, and a pair of left and right second side plate portions extending downward from the covering portion, each of the second side plate portions includes a curved portion that is disposed above the bottom plate portion and between the first side plate portions, and that is curved outward in a left-right direction from an upper end to a lower end of the curved portion, lower end portions of the curved portions are in contact with an upper surface of the bottom plate portion while being abutted against each other, and an intermediate portion of each of the curved portions in an extension direction of the corresponding second side plate portion is in contact with an opposing inner surface of the first side plate portion.

According to the present disclosure, it is possible to suppress variations in signal transmission performance among shield terminals, thus achieving improved signal transmission performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional side view of a shield terminal according to Embodiment 1.

FIG. 2 is a perspective view showing a first outer conductor.

FIG. 3 is a perspective view showing a second outer conductor to which a second dielectric is mounted.

FIG. 4 is a cross-sectional view showing a state in which second side plate portions of the second outer conductor are inserted between first side plate portions of the first outer conductor.

FIG. 5 is a cross-sectional view taken along the line A-A in FIG. 1.

FIG. 6 is a cross-sectional view taken along the line B-B in FIG. 1.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Description of Embodiments of the Present Disclosure]

First, embodiments of the present disclosure will be listed and described.

(1) A shield terminal including: a first outer conductor and a second outer conductor that are connectable to each other, wherein the first outer conductor includes a bottom plate portion, a pair of left and right first side plate portions extending upward from the bottom plate portion, and an opening formed between upper ends of the first side plate portions, the second outer conductor includes a covering portion that covers the opening, and a pair of left and right second side plate portions extending downward from the covering portion, each of the second side plate portions includes a curved portion that is disposed above the bottom plate portion and between the first side plate portions, and that is curved outward in a left-right direction from an upper end to a lower end of the curved portion, lower end portions of the curved portions are in contact with an upper surface of the bottom plate portion while being abutted against each other, and an intermediate portion of each of the curved portions in an extension direction of the corresponding second side plate portion is in contact with an opposing inner surface of the first side plate portion.

With the shield terminal according to (1), the second outer conductor can be brought into elastic contact with the first outer conductor by the curved portions, and it is therefore possible to reliably achieve and maintain a state in which the first outer conductor and the second outer conductor are in contact with each other, regardless of variations in dimensions of components and variations in mounting.

(2) The shield terminal according to (1), wherein each of the curved portions forms an air layer between the curved portion and at least one of a dielectric disposed between the two second side plate portions, and a central conductor of a shielded wire disposed between the two second side plate portions.

With the shield terminal according to (2), forming the air layers can increase the impedances at the curved portions, and therefore the impedances at the curved portions can be easily adjusted.

(3) The shield terminal according to (1) or (2), wherein lower end portions of the second side plate portions extend in a front-rear direction, one part, in the front-rear direction, of the lower end portion of each of the second side plate portions is provided with a protrusion protruding downward relative to other parts of the lower end portion other than the one part, and the protrusions are abutted against each other and located at lower end portions of the corresponding curved portions.

With the shield terminal according to (3), one part of the lower end portion of each of the second side plate portions that extends in the front-rear direction is provided with a protrusion protruding downward relative to other parts of the lower end portion other than the one part. Accordingly, at the time of abutting the lower end portions of the two second side plate portions against each other using a crimping machine or the like, the pressing force of the crimping machine is likely to be focused on the protrusions, and therefore a curved portion is formed at the position (i.e., the part) of the protrusion. Accordingly, by changing the position of the one part of the lower end portion of each of the second side plate portions, each of the curved portions can be more easily provided at a desired position in the front-rear direction.

### [Details of Embodiments of the Present Disclosure]

### Embodiment 1

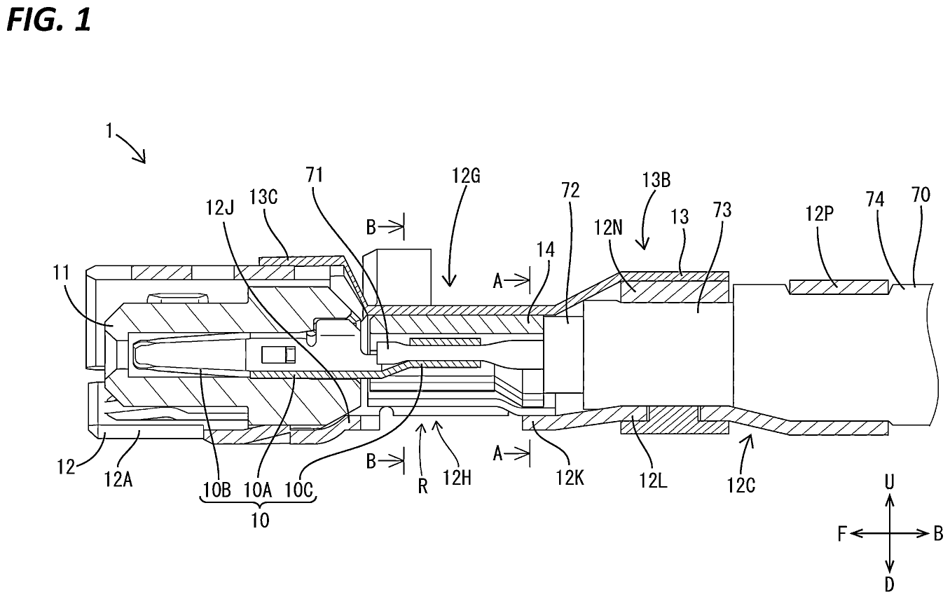

Embodiment 1 as an implementation of a shield terminal 1 according to the present disclosure will be described with reference to FIGS. 1 to 6. In the drawings, “F”, “B”, “U”, “D”, “R”, and “L” denote “front side”, “rear side”, “upper side”, “lower side”, “right side”, and “left side”, respectively. Note that the reference directions are defined for the sake of convenience, and do not necessarily coincide with the corresponding directions in a state in which a connector including the shield terminal 1 is mounted in a vehicle or the like. For example, the up-down direction is not limited to the direction of gravity.

### [Configuration of Shield Terminal]

As shown in FIG. 1, the shield terminal 1 includes an inner conductor 10, a first dielectric 11, a first outer conductor 12, a second outer conductor 13, a second dielectric 14, which is a dielectric, and a shielded wire 70. The inner conductor 10 is formed by pressing a metal plate material, and has an overall shape that is elongated in the front-rear direction. The inner conductor 10 includes a tubular body portion 10A, a pair of elastic contact portions 10B extending forward in a cantilevered manner from the body portion 10A, and a crimping portion 10C having the shape of an open barrel protruding rearward from the body portion 10A.

The first dielectric 11 is made of synthetic resin, and has the shape of a cylinder whose axis is directed in the front-rear direction. The body portion 10A and the elastic contact portions 10B of the inner conductor 10 are accommodated inside the first dielectric 11. The crimping portion 10C protrudes rearward relative to a rear end face of the first dielectric 11.

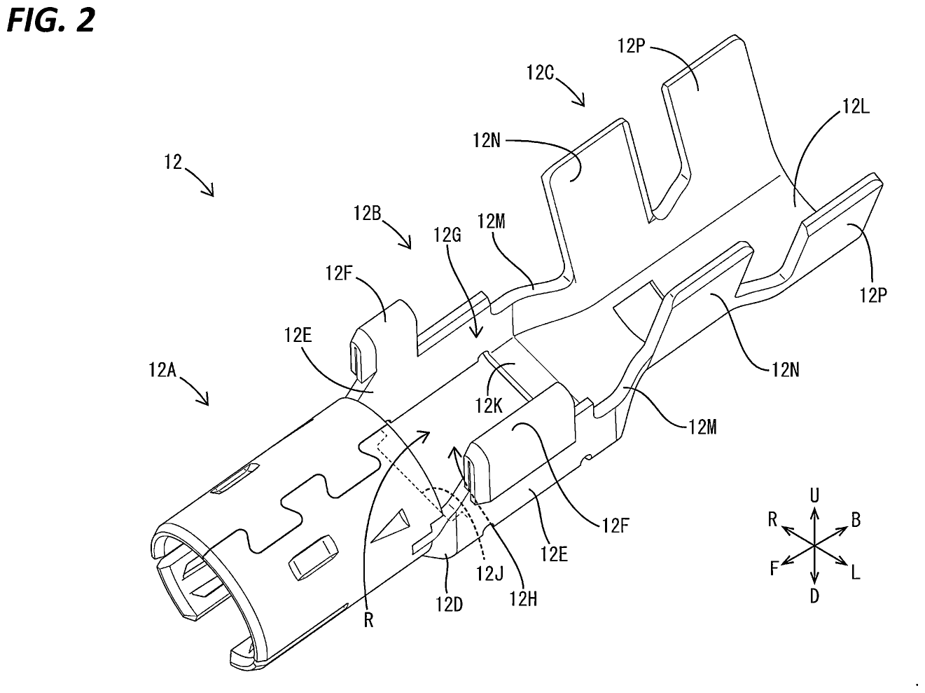

The first outer conductor 12 is formed by pressing a metal plate material, and has an overall shape that is elongated in the front-rear direction. As shown in FIG. 2, the first outer conductor 12 includes a tubular shield portion 12A, a connection shield portion 12B, and a crimping shield portion 12C. The tubular shield portion 12A constitutes a front end portion of the first outer conductor 12, and has the shape of a cylinder whose axis is directed in the front-rear direction. The body portion 10A and the elastic contact portions 10B of the inner conductor 10, and the entire first dielectric 11 are accommodated inside the tubular shield portion 12A (see FIG. 1).

The connection shield portion 12B includes one front wall portion 12D, a pair of bilaterally symmetrical, plate-shaped first side plate portions 12E respectively connected with opposite end edges of the front wall portion 12D in the left-right direction, and a pair of bilaterally asymmetrical stabilizers 12F having different lengths in the front-rear direction. The front wall portion 12D is connected with a lower half region of a rear end edge of the tubular shield portion 12A and bulges in a flange shape from an outer circumference of the tubular shield portion 12A. A lower end portion of the front wall portion 12D extends in the left-right direction (not shown). The opposite edges of the front wall portion 12D in the left-right direction extend in the up-down direction.

The two first side plate portions 12E are disposed parallel to each other and spaced apart from each other in the left-right direction, with the plate thickness directions thereof oriented in the left-right direction. Front end edges of the first side plate portions 12E are respectively connected with the opposite edges of the front wall portion 12D in the left-right direction. Each of the stabilizers 12F is formed so as to protrude upward from a front end portion of an upper end edge of the corresponding first side plate portion 12E and be folded back outward in the left-right direction.

A connection space R defined by the two first side plate portions 12E is formed on an inner side of the connection shield portion 12B in the left-right direction. The crimping portion 10C of the inner conductor 10 is accommodated inside the connection space R (see FIG. 1). An upper surface of the connection shield portion 12B constitutes a first opening 12G serving as an opening for opening the connection space R to the outside upward of the connection shield portion 12B. The first opening 12G is formed between upper ends of the two first side plate portions 12E. The first opening 12G is open over substantially the entire region of the connection shield portion 12B in the front-rear direction.

A lower surface of the connection shield portion 12B constitutes a second opening 12H for opening the connection space R to the outside downward of the connection shield portion 12B. Due to the connection space R, the first opening 12G, and the second opening 12H, the connection shield portion 12B has a form in which a space passes through in the up-down direction. The opening range of the second opening 12H in the front-rear direction is a region extending from a position rearward of a front end of the connection shield portion 12B to a position forward of a rear end of the connection shield portion 12B. That is, the opening dimension of the second opening 12H in the front-rear direction is smaller than the opening dimension of the first opening 12G in the front-rear direction.

The lower surface of the connection shield portion 12B is provided with a front bottom plate portion 12J, and a rear bottom plate portion 12K serving as a bottom plate portion. The front bottom plate portion 12J is formed extending in the left-right direction, with the plate thickness direction thereof oriented in the up-down direction. The front bottom plate portion 12J forms a front edge of an opening edge of the second opening 12H. A front end edge of the front bottom plate portion 12J is connected with a lower edge of the front wall portion 12D. Opposite ends of the front bottom plate portion 12J in the left-right direction are connected with front end portions of lower edge portions of the respective first side plate portions 12E. The front bottom plate portion 12J forms a right angle with each of the first side plate portions 12E. The front bottom plate portion 12J is configured to span between the two first side plate portions 12E (not shown).

As in the case of the front bottom plate portion 12J, the rear bottom plate portion 12K is formed extending in the left-right direction, with the plate thickness direction thereof oriented in the up-down direction. The rear bottom plate portion 12K forms a rear edge of the opening edge of the second opening 12H. Opposite ends of the rear bottom plate portion 12K in the left-right direction are connected at right angles with rear end portions of the lower edge portions of the respective first side plate portions 12E. The rear bottom plate portion 12K is configured to span between the two first side plate portions 12E. In other words, the two first side plate portions 12E extend upward from the rear bottom plate portion 12K. The rear bottom plate portion 12K also has the function for causing protrusions 13H, which will be described later, of the second outer conductor 13 to be abutted thereagainst. The interval between a rear end edge of the front bottom plate portion 12J and a front end edge of the rear bottom plate portion 12K is the opening dimension of the second opening 12H in the front-rear direction (see FIG. 1).

The crimping shield portion 12C includes a bottom wall portion 12L, a pair of bilaterally symmetrical support wall portions 12M, a pair of left and right shield caulking pieces 12N, and a pair of left and right sheath caulking pieces 12P. The bottom wall portion 12L is connected with a rear end of the rear bottom plate portion 12K, and extends rearward from the rear bottom plate portion 12K. The support wall portions 12M are connected with rear end edges of the respective first side plate portions 12E, and extend rearward from the first side plate portions 12E. Lower edges of the support wall portions 12M are connected with front end portions of opposite edges of the bottom wall portion 12L in the left-right direction. Rear end portions of the first side plate portions 12E, the rear bottom plate portion 12K, the front end portion of the bottom wall portion 12L, and the support wall portions 12M form the shape of a box that is open in the upward direction and both the forward and rearward directions.

The shield caulking pieces 12N extend upward from central portions, in the front-rear direction, of the opposite edges of the bottom wall portion 12L in the left-right direction. The sheath caulking pieces 12P extend upward from rear end portions, in the front-rear direction, of the opposite edges of the bottom wall portion 12L in the left-right direction.

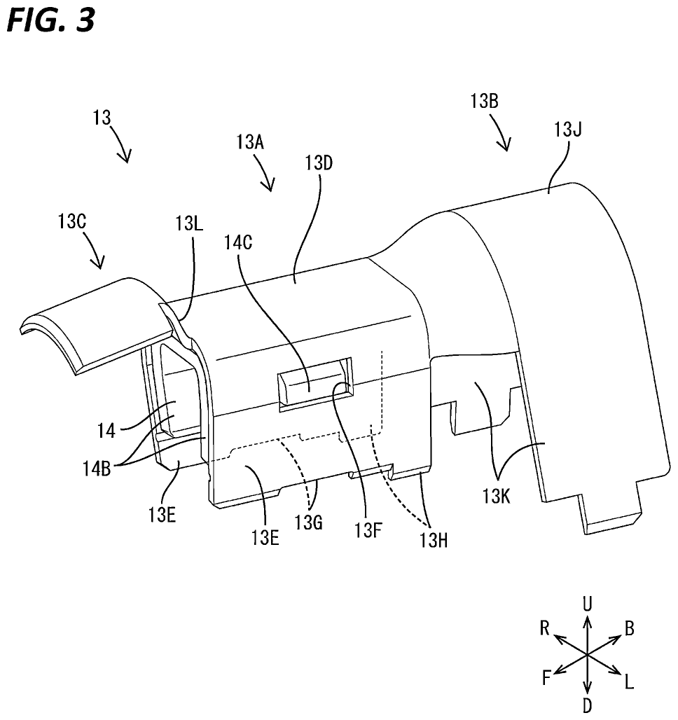

The second outer conductor 13 is formed by pressing a metal plate material. As shown in FIG. 3, the second outer conductor 13 includes a connection portion surrounding portion 13A in which a lower surface and front and rear surfaces are open, a shield surrounding portion 13B, and a connection piece portion 13C.

In the second outer conductor 13 before being mounted to the first outer conductor 12, the connection portion surrounding portion 13A includes a covering portion 13D with the plate thickness direction oriented in the up-down direction, and a pair of bilaterally symmetrical second side plate portions 13E that are spaced apart from each other and extend downward from left and right edges of the covering portion 13D. Lower end portions of the second side plate portions 13E extend in the front-rear direction. The second side plate portions 13E each have a locking hole 13F extending therethrough in the plate thickness direction. A recess 13G recessed toward the covering portion 13D is formed on a central portion, in the front-rear direction, of the lower end portion (protruding end edge from the covering portion 13D) of each of the second side plate portions 13E.

A protrusion 13H protruding downward (in a direction away from the covering portion 13D) is formed at a rear end portion (i.e., one part, in the front-rear direction, of the lower end portion of the corresponding second side plate portion 13E) of the lower end portion (protruding end edge from the covering portion 13D) of each of the second side plate portions 13E. Each of the protrusions 13H protrudes downward relative to a part of the lower end portion (protruding end edge from the covering portion 13D) of the corresponding second side plate portion 13E other than the rear end portion (i.e., other parts of the second side plate portion 13E other than the one part).

The dimension of the second side plate portions 13E in the front-rear direction is smaller than the opening dimension of the first opening 12G in the front-rear direction (not shown). The opening dimension of the first opening 12G in the front-rear direction is the dimension between a rear end of the tubular shield portion 12A and front ends of the shield caulking pieces 12N (see FIG. 1). The dimension of each of the second side plate portions 13E in the front-rear direction is larger than the opening dimension of the second opening 12H in the front-rear direction (not shown). The opening dimension of the second opening 12H in the front-rear direction is the dimension between a rear end of the front bottom plate portion 12J and a front end of the rear bottom plate portion 12K (see FIG. 1).

The shield surrounding portion 13B is connected with a rear end portion of the covering portion 13D, and extends rearward from the connection portion surrounding portion 13A. In the second outer conductor 13 before being mounted to the first outer conductor 12, the shield surrounding portion 13B has the shape of an open barrel including a base portion 13J connected with the covering portion 13D, and a pair of caulking portions 13K extending from left and right edges of the base portion 13J. The connection piece portion 13C has the shape of a circular arc, is oriented such that an inner surface thereof faces downward and an axis thereof is oriented in the front-rear direction, and is disposed forward of the covering portion 13D and above the covering portion 13D. A rear end of the connection piece portion 13C is coupled to a coupling portion 13L extending upward from a front end edge of the covering portion 13D.

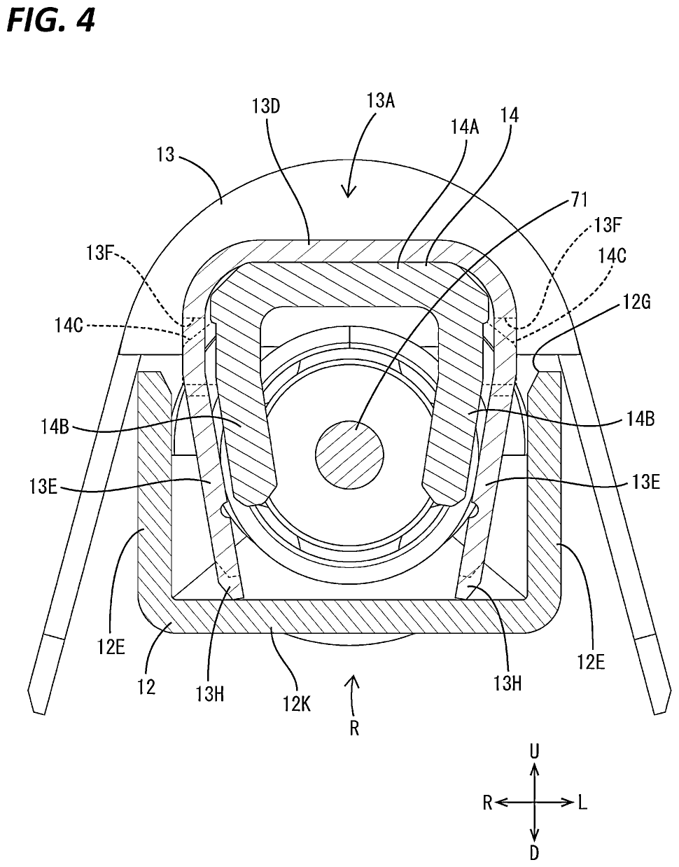

The second dielectric 14 is made of synthetic resin, and has a configuration similar to that of the connection portion surrounding portion 13A. As shown in FIG. 4, the second dielectric 14 has includes an upper surface portion 14A having the shape of a horizontal plate, and a pair of left and right side surface portions 14B extending downward from opposite edges of the upper surface portion 14A in the left-right direction. The upper surface portion 14A is overlaid on a lower surface of the covering portion 13D, and the side surface portions 14B are overlaid on inner surfaces of the respective second side plate portions 13E in the left-right direction. The second dielectric 14 is kept mounted to the second outer conductor 13 by causing locking projections 14C provided on outer surfaces of the side surface portions 14B to be locked to the respective locking holes 13F of the second outer conductor 13.

As shown in FIG. 1, the shielded wire 70 is a wire having a well-known configuration including a central conductor 71, a tubular insulator 72 surrounding the central conductor 71, a tubular shield layer 73 made of a braided wire or the like disposed along an outer circumference of the tubular insulator 72, and a sheath 74 surrounding the shield layer 73. The sheath 74 is removed at a front end portion of the shielded wire 70, whereby a front end portion of the shield layer 73 is exposed while being overlaid on the outer circumference of the tubular insulator 72, and the central conductor 71 protrudes forward while being exposed from a front end of the tubular insulator 72.

### [Example of Mounting Procedure of Shield Terminal]

Next, an example of a mounting procedure of the shield terminal 1 will be described. The first dielectric 11 in the state of surrounding the inner conductor 10 is mounted to the first outer conductor 12. As shown in FIG. 1, in a state in which the first dielectric 11 and the first outer conductor 12 are mounted to each other, the inner conductor 10 is accommodated inside the tubular shield portion 12A, and the crimping portion 10C of the inner conductor 10 protrudes rearward from the first dielectric 11 and is accommodated inside the connection space R of the first outer conductor 12. Before or after the mounting process of the inner conductor 10 and the first outer conductor 12, the front end portion of the shielded wire 70 and the crimping shield portion 12C of the first outer conductor 12 are connected to each other. At this time, the shield caulking pieces 12N are crimped to an outer circumference of the shield layer 73 of the shielded wire 70 by caulking, and the sheath caulking pieces 12P are crimped to an outer circumference of the sheath 74 by caulking.

In a state in which the shielded wire 70 and the first outer conductor 12 are connected to each other, the central conductor 71 protruding forward from the tubular insulator 72 is accommodated inside the connection space R. In the connection space R, the crimping portion 10C of the inner conductor 10 is crimped to the central conductor 71 by caulking. The crimping process between the central conductor 71 and the crimping portion 10C is performed by advancing an anvil (not shown) and a crimper (not shown) of a crimping machine (not shown) into the connection space R from the first opening 12G and the second opening 12H, respectively.

After the first dielectric 11, the inner conductor 10, and the shielded wire 70 have been mounted to the first outer conductor 12, the second dielectric 14 to which the second outer conductor 13 has been mounted is mounted to the first outer conductor 12. The first outer conductor 12 and the second outer conductor 13 are connectable to each other. At the time of mounting the second outer conductor 13 to the first outer conductor 12, as shown in FIG. 4, the connection portion surrounding portion 13A is inserted into the first opening 12G from above the first outer conductor 12, with the second side plate portions 13E oriented so as to extend downward from the covering portion 13D. Then, the protrusions 13H of the second side plate portions 13E are abutted against an upper surface of the rear bottom plate portion 12K. At this time, the dimension between outer sides of the second side plate portions 13E in the left-right direction is smaller than the dimension between inner sides of the two first side plate portions 12E in the left-right direction. At this time, the second dielectric 14 is adjacent to the front of the tubular insulator 72 (see FIG. 1).

Next, inside the connection space R, the second side plate portions 13E of the second outer conductor 13 and the side surface portions 14B of the second dielectric 14 are pressed into shapes surrounding the connection portion between the inner conductor 10 and the central conductor 71. This pressing is performed by advancing dies of the crimping machine (not shown) into the connection space R from the first opening 12G and the second opening 12H, and pressing the connection portion surrounding portion 13A from the up-down direction.

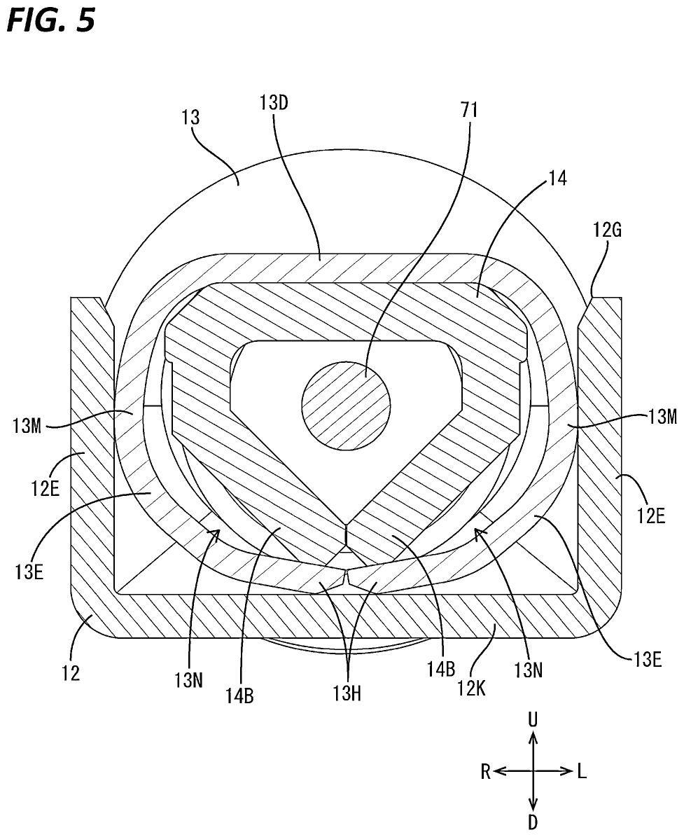

As shown in FIG. 5, as a result of performing pressing using the crimping machine, the second side plate portions 13E are deformed such that the lower end portions thereof approach each other inwardly in the left-right direction. Specifically, the protrusions 13H of the second side plate portions 13E approach each other inwardly in the left-right direction, while coming into contact with the upper surface of the rear bottom plate portion 12K, and thereafter lower end edges of the protrusions 13H are abutted against each other.

Rear end portions of the portions of the second side plate portions 13E at the portions where the protrusions 13H are formed in the front-rear direction are deformed such that central portions thereof in the up-down direction bulge outward in the left-right direction, and elastically come into contact with inner surfaces of the two first side plate portions 12E in the left-right direction. In this manner, a curved portion 13M that is disposed above the rear bottom plate portion 12K and between the first side plate portions 12E, and that is curved outward in the left-right direction from an upper end to a lower end of the curved portion 13M is formed at the rear end portion of each of the second side plate portions 13E. That is, each of the second side plate portions 13E includes a curved portion 13M. The curved portions 13M are formed at the rear end portions of the respective second side plate portions 13E.

A protrusion 13H is located at a lower end portion of each of the curved portions 13M. The lower end portions of the curved portions 13M (lower end edges of the protrusions 13H) are in elastic contact with the upper surface of the rear bottom plate portion 12K while being abutting against each other. An intermediate portion of each of the curved portions 13M in the extension direction (up-down direction) of the corresponding second side plate portion 13E is in elastic contact with an inner surface (an opposing inner surface) of the first side plate portion 12E in the left-right direction. The covering portion 13D covers the first opening 12G so as to block the first opening 12G from above.

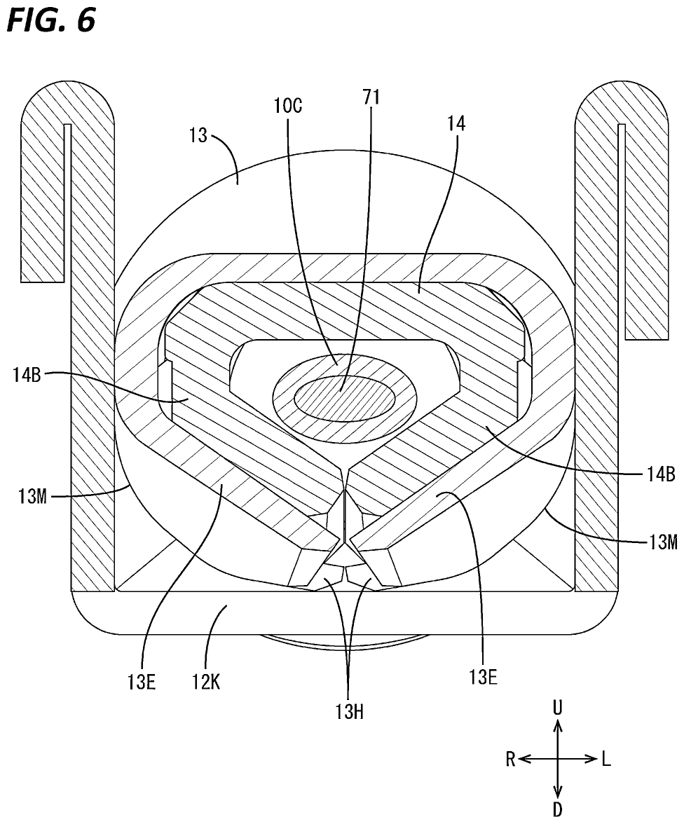

Other parts of each of the second side plate portions 13E in the front-rear direction other than a part where the protrusion 13H are provided (a portion of the second side plate portion 13E that is located forward of the protrusion 13H) is deformed so as to be inclined inwardly downward in the left-right direction by pressing using the crimping machine (see FIG. 6).

The side surface portions 14B of the second dielectric 14 are pressed inward in the left-right direction by the respective second side plate portions 13E. Accordingly, the side surface portions 14B are deformed in the entire front-rear direction such that lower end portions thereof approach each other inward in the left-right direction, whereby the lower end portions are abutted against each other. Thus, the central conductor 71 protruding forward from the tubular insulator 72 is surrounded by the second dielectric 14.

The curved portions 13M are spaced apart from the corresponding side surface portions 14B of the second dielectric 14 disposed between the two second side plate portions 13E (see FIG. 5). An air layer 13N is formed between an inner surface of each of the curved portions 13M in the left-right direction and an outer surface of the corresponding side surface portion 14B in the left-right direction (see FIG. 5).

The shield surrounding portion 13B of the second outer conductor 13 surrounds the shield caulking pieces 12N caulked to the outer circumference of the shield layer 73 and the bottom wall portions 12L, and is crimped to the outer circumferences of the shield caulking pieces 12N and the bottom wall portion 12L by caulking (see FIG. 1). The connection piece portion 13C is in elastic contact with the outer circumference of the rear end portion of the tubular shield portion 12A from above (see FIG. 1).

Next, operations of Embodiment 1 will be described.

The shield terminal 1 includes a first outer conductor 12 and a second outer conductor 13 that are connectable to each other. The first outer conductor 12 includes a rear bottom plate portion 12K, a pair of left and right first side plate portions 12E extending upward from the rear bottom plate portion 12K, and a first opening 12G formed between upper ends of the first side plate portions 12E. The second outer conductor 13 includes a covering portion 13D that covers the first opening 12G, and a pair of left and right second side plate portions 13E extending downward from the covering portion 13D. Each of the second side plate portions 13E includes a curved portion 13M that is disposed above the rear bottom plate portion 12K and between the first side plate portions 12E, and that is curved outward in the left-right direction from an upper end to a lower end of the curved portion 13M. Lower end portions of the curved portions 13M include portions that are in contact with an upper surface of the rear bottom plate portion 12K while being abutted against each other. An intermediate portion of each of the curved portions 13M in the extension direction of the corresponding second side plate portion 13E includes a portion that is in contact with an opposing inner surface of the first side plate portion 12E.

With this configuration, the second outer conductor 13 can be brought into elastic contact with the first outer conductor 12 by the curved portions 13M, and it is therefore possible to reliably achieve and maintain a state in which the first outer conductor 12 and the second outer conductor 13 are in contact with each other, regardless of variations in dimensions of components and variations in mounting.

Each of the curved portions 13M forms an air layer 13N between the curved portion 13M and the second dielectric 14 disposed between the two second side plate portions 13E. With this configuration, forming the air layers 13N can increase the impedances at the curved portions 13M, and therefore the impedances at the curved portions 13M can be easily adjusted.

Lower end portions of the second side plate portions 13E extend in the front-rear direction, and a part, in the front-rear direction, of the lower end portion of each of the second side plate portions 13E is provided with a protrusion 13H protruding downward of other parts of the lower end portion other than the part, and the protrusions 13H are abutted against each other and located at lower end portions of the respective curved portions 13M. With this configuration, one part of the lower end portion of each of the second side plate portions 13E that extends in the front-rear direction is provided with a protrusion 13H protruding downward relative to other parts of the lower end portion other than the one part. Accordingly, at the time of abutting the lower end portions of the two second side plate portions 13E against each other by pressing using a crimping machine, the pressing force of the crimping machine is likely to be focused on the protrusions 13H, and therefore a curved portion 13M is formed at the position (i.e., the part) of the protrusion 13H. Accordingly, by changing the position of the one part of the lower end portion of each of the second side plate portions 13E, each of the curved portions 13M can be more easily provided at a desired position in the front-rear direction.

### OTHER EMBODIMENTS

It should be appreciated that the embodiment disclosed herein is to be construed in all respects as illustrative and not limiting. The scope of the present invention is not limited to the embodiments disclosed herein, but is defined by the claims, and is intended to include all modifications which fall within the scope of the claims and the meaning and scope of equivalents thereof.

Unlike Embodiment 1, it is possible to adopt a configuration in which the second dielectric is not provided. In this case, each of the curved portions forms an air layer so as to be spaced apart from the central conductor of the shielded wire disposed between the two second side plate portions. The second dielectric may be provided so as to overlap a part of each of the curved portions in the front-rear direction. In this case, each of the curved portions forms an air layer between the curved portion and the dielectric disposed between the two second side plate portions, and between the curved portion and the central conductor of the shielded wire disposed between the two second side plate portions.

Unlike Embodiment 1, a front end portion of each of the second side plate portions may be provided with a protrusion, and the protrusions may be pressed while being in contact with an upper surface of the front bottom plate portion, thus forming curved portions at front end portions of the second side plate portions.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield terminal comprising:
a first outer conductor and a second outer conductor that are connectable to each other,
wherein the first outer conductor includes a bottom plate portion, a pair of left and right first side plate portions extending upward from the bottom plate portion, and an opening formed between upper ends of the first side plate portions,
the second outer conductor includes a covering portion that covers the opening, and a pair of left and right second side plate portions extending downward from the covering portion,
each of the second side plate portions includes a curved portion that is disposed above the bottom plate portion and between the first side plate portions, and that is curved outward in a left-right direction from an upper end to a lower end of the curved portion,
lower end portions of the curved portions are in contact with an upper surface of the bottom plate portion while being abutted against each other, and
an intermediate portion of each of the curved portions in an extension direction of the corresponding second side plate portion is in contact with an opposing inner surface of the first side plate portion.

2. The shield terminal according to claim 1, wherein each of the curved portions forms an air layer between the curved portion and a dielectric disposed between the two second side plate portions.

3. The shield terminal according to claim 1,
wherein lower end portions of the second side plate portions extend in a front-rear direction,
one part, in the front-rear direction, of the lower end portion of each of the second side plate portions is provided with a protrusion protruding downward relative to other parts of the lower end portion other than the one part, and
the protrusions are abutted against each other and located at lower end portions of the respective curved portions.
